(19) United States
(12) Patent Application Publication
(10) Pub. No.: US 2026/0212054 A1
(43) Pub. Date: Jul. 23, 2026

(54) CENTRALLY MANAGEABLE LOCKING CHASSIS

(71) Applicant: Dell Products L.P., Round Rock, TX (US)

(72) Inventors: Xin Zhi Ma, Shanghai City (CN); Ahmad A.J. Ali, Austin, TX (US)

(21) Appl. No.: 19/034,178

(22) Filed: Jan. 22, 2025

(51) Int. Cl. G06F 21/88

(52) U.S. Cl. CPC G06F 21/88; G06F 2221/2153

(57) ABSTRACT

A method for unlocking a secure computing system. The method also includes entering an access key by a user via a user interface of a secure computing system, wherein the access key is generated by an administrative system that is external to the secure computing system. In addition, the method also includes authenticating, by the secure computing system, the access key. Moreover, the method includes in response to the authentication initiating an unlocking of a lock mechanism on the secure computing system, wherein once unlocked, the user may access at least one internal hardware component of the secure computing system.

### BACKGROUND

Information Technology (IT) personnel often need to gain physical access to computing systems. However, computing systems often contain sensitive information and/or components that an owner of the computing system may want to restrict access.

### BRIEF DESCRIPTION OF DRAWINGS

Certain embodiments of the disclosure will now be described with reference to the accompanying drawings. However, the accompanying drawings illustrate only certain aspects or implementations of the disclosure by way of example and are not meant to limit the scope of the claims.

FIG. 1 shows a diagram of a system in accordance with one or more embodiments.

FIG. 2 shows a diagram of a secure computing system in accordance with one or more embodiments of the invention.

FIG. 3.1 shows a flowchart of a method for sending an unlock request to a secure computing system in accordance with one or more embodiments of the invention.

FIG. 3.2 shows a flowchart of a method for sending an unlock request to a secure computing system in accordance with one or more embodiments of the invention.

FIG. 4 shows a flowchart of a method for unlocking a secure computing system in accordance with one or more embodiments of the invention.

FIG. 5.1 shows a flowchart of a method for sending an unlock request to a secure computing system in accordance with one or more embodiments of the invention.

FIG. 5.2 shows a flowchart of a method for unlocking a secure computing system in accordance with one or more embodiments of the invention.

FIG. 6 shows a diagram of a computing system in accordance with one or more embodiments of the invention.

### DETAILED DESCRIPTION

With the rise of edge computing, more and more computing systems are being deployed in unattended environments, posing challenges to their physical security. Hardware components of these systems are commonly housed within chassis (or enclosure), which function as structural enclosures designed to organize and protect the hardware components (e.g., motherboards, storage devices, processors, etc.). These chassis are often designed for ease of access to allow for easy removal and installation of the hardware components. In some cases, chassis may include mechanical locks for intrusion protection. Unfortunately, mechanical locks offer limited protection as they can be easily forced open or bypassed. Further, mechanical locks are often unlockable by physical keys that can be copied and/or stolen. Additionally, traditional chassis do not offer any way to detect if a chassis has been broken into or left open. Thus, traditional chassis cannot prevent malicious actions after the chassis is opened, such as component theft and/or installation of compromised components. Therefore, there is a need for enhanced chassis protection systems to ensure the protection of sensitive information and/or hardware components.

As a result of the limitations of traditional mechanisms to protect hardware within a chassis discussed above, embodiments of the invention are directed to secure computing system. The secure computing system is a secure chassis that governs access to the components housed within the chassis using a remotely controlled (or remotely managed) access system.

Specific embodiments will now be described with reference to the accompanying figures.

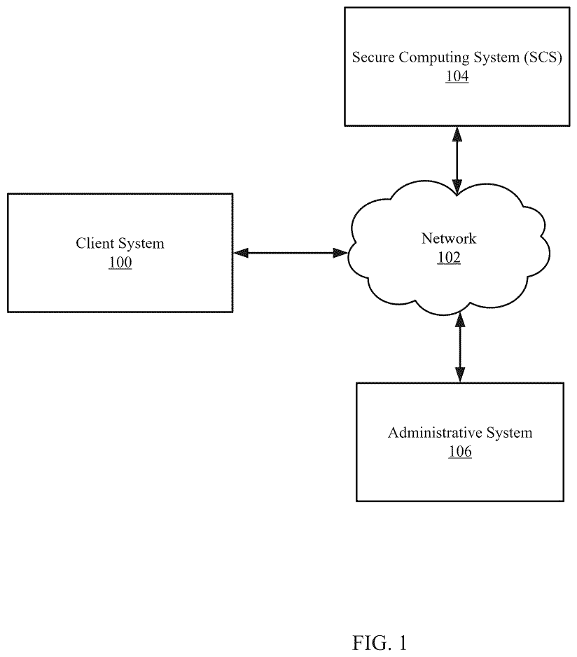

FIG. 1 shows a system in accordance with one or more embodiments. The system may include a client system (100), a network (102), a secure computing system (SCS) (104), and an administrative system (106). The system may include additional, fewer, and/or different components without departing from the scope of the invention. Each of these system components is described below.

In one or more embodiments, the client system (100), the SCS (104), and the administrative system (106) may be operatively connected to one another through the network (102) (e.g., a local area network (LAN), a wide area network (WAN) such as the Internet, a mobile network, any other network type, or a combination thereof). Further, the network (102) may encompass various interconnected, network-enabled subcomponents (or systems) (e.g., switches, routers, gateways, etc.) that may facilitate communications between the aforementioned components. Moreover, the client system (100), the SCS (104), and the administrative system (106) may communicate with one another using any combination of wired and/or wireless communication protocols.

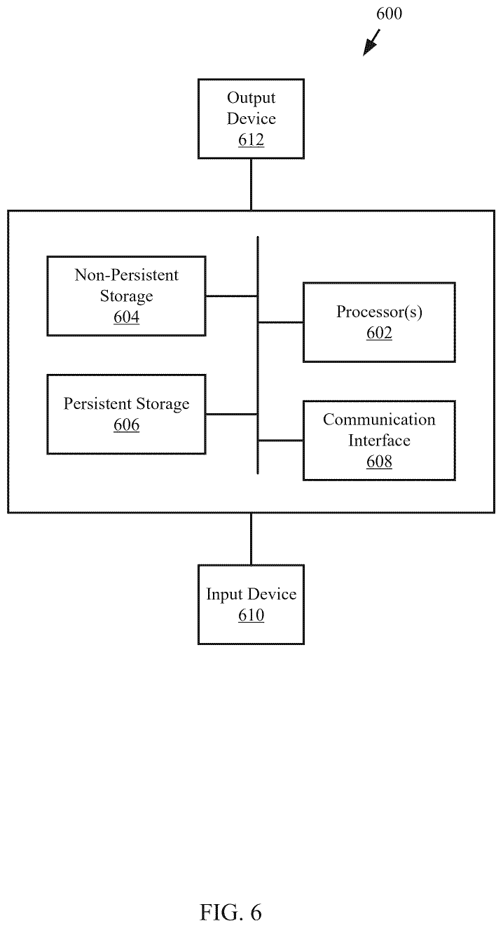

In one or more embodiments, the client system (100), the SCS (104), and the administrative system (106) may be located on a single physical (see e.g., FIG. 6) and/or logical computing system.

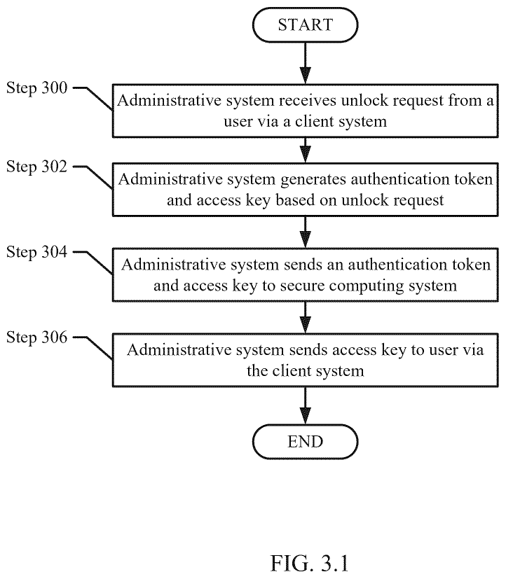

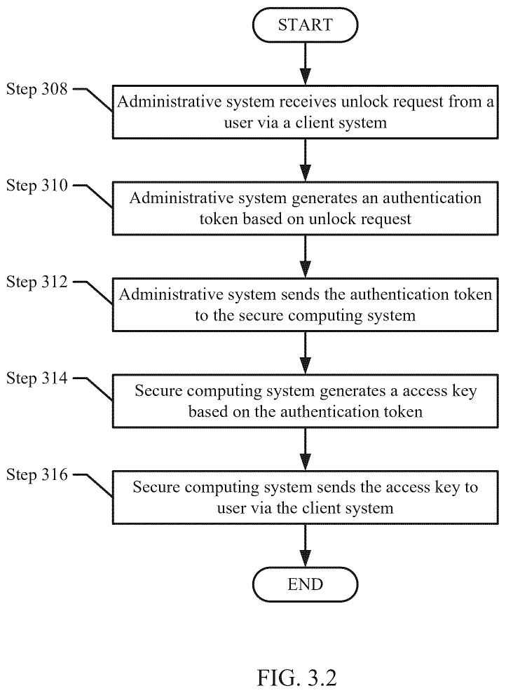

In one or more embodiments, the client system (100) includes the functionality to permit users to interact with the SCS (104). Further, the client system (100) includes functionality to perform at least a portion of the methods shown in FIGS. 3-5. One of ordinary skill will appreciate that the client system (100) may perform other functionalities without departing from the scope of the invention.

In one or more embodiments, disclosed herein, the client system (100) may be a physical device (see e.g., FIG. 6) such as, e.g., a laptop, a cell phone, a tablet computer, a server, etc. In another embodiment of the invention, the client system (100) may be implemented on a virtual device (e.g., a virtual machine executing on one or more physical devices).

In one or more embodiments, the SCS (104) includes the functionality to control access to components within the SCS (104). In one or more embodiments, the SCS (104) includes the functionality to detect and respond to unauthorized access to the components in the SCS (104). In one or more embodiments, disclosed herein, the SCS (104) may be a physical device (see e.g., FIG. 6) such as, e.g., a laptop, a cell phone, a tablet computer, a server, etc. Further, the SCS (104) includes functionality to perform at least a portion of the methods shown in FIGS. 3-5. One of ordinary skill will appreciate that the SCS (104) may perform other functionalities without departing from the scope of the invention.

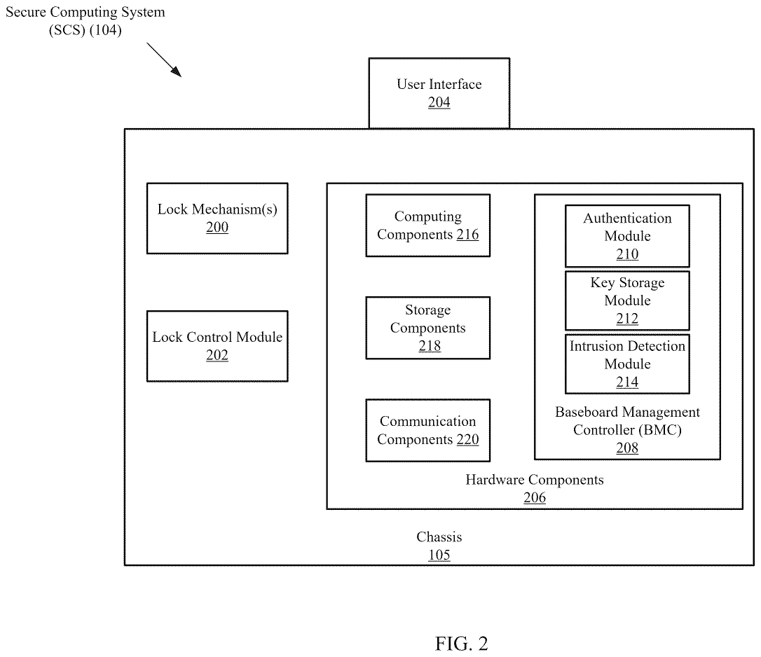

In one or more embodiments, the administrative system (106) includes the functionality to generate authentication tokens and/or access keys in response to receiving user input (i.e., unlock requests). In one or more embodiments, the access key may be generated by other components within the SCS (104) as described below in FIG. 2. In one or more embodiments, the authentication token may refer to an encrypted string of data containing information about an unlock request (i.e., which components to grant the user access to and for how long). In one or more embodiments, the access key may refer to a unique string of characters and/or cryptographic variables that the user inputs into a user interface (e.g., 204 in FIG. 2) to gain access to the components in the SCS (104). It should be further appreciated, that each authentication token may have an access key associated with it and vice versa. Further, the administrative system (106) includes functionality to perform at least a portion of the methods shown in FIGS. 3-5. One of ordinary skill will appreciate that the administrative system (106) may perform other functionalities without departing from the scope of the invention.

In one or more embodiments disclosed herein, the administrative system (106) may be a physical device (see e.g., FIG. 6) such as, e.g., a laptop, a cell phone, a tablet computer, a server, etc. In another embodiment of the invention, the administrative system (106) may be implemented on a virtual device (e.g., a virtual machine executing on one or more physical devices).

FIG. 2 shows a SCS (e.g., 104 in FIG. 1) in accordance with one or more embodiments of the invention. More specifically, in one or more embodiments of the invention, the SCS (e.g., 104 in FIG. 1) includes a chassis (105), a lock mechanism (200), a lock control module (202), and a user interface (204). The aforementioned components are used to control physical access to the hardware components (206), a baseboard management controller (BMC) (208), an authentication module (210), a key storage module (212), an intrusion detection module (214), computing components (216), storage components (218), communication components (220) or any other components located (or mounted) within the chassis (105). It should be appreciated, that the chassis may be the chassis of a server or any other computing system (e.g., network switches, workstations, desktops, etc.) Each of the aforementioned components may be operably/operatively connected to any of the other aforementioned components via any combination of wired and/or wireless connections. Each of these system components is described below.

In one or more embodiments, the chassis is a physical enclosure in which the hardware components (206) are housed. Though not shown in in FIG. 2, the chassis may include a front panel on which the user interface (204) is installed. The front panel is in a lock or unlocked state based on the operation of the lock mechanism(s) (200) and the lock control module (202) (as further described below). The chassis may also have a back panel and a cover (not shown), where the back panel and the cover is in a lock or unlocked state based on the operation of the lock mechanism(s) (200) and the lock control module (202). The front panel, the back panel, and the cover may be individually and collectively referred to as physical access points.

In one or more embodiments, the lock mechanism (200) is a physical component which includes the functionality to control access to the hardware components (206) of the SCS (e.g., 104 in FIG. 1). It should be appreciated, that controlling access to the hardware components (206) may include but is not limited to, locking the physical access to prevent access to the hardware components (206). In one or more embodiments, the lock mechanism (200) remains in a locked position by default regardless of the SCS's (e.g., 104 in FIG. 1) power state. In one or more embodiments, the lock mechanism (200) may lock if SCS (e.g., 104 in FIG. 1) loses power. In one or more embodiments, the lock mechanism (200) may stay unlocked when the SCS (e.g., 104 in FIG. 1) loses power if the lock mechanism was authorized to be unlocked by the SCS (e.g., 104 in FIG. 1) prior to the SCS (e.g., 104 in FIG. 1) losing power. It should be appreciated, that the SCS (e.g., 104 in FIG. 1) may include more than one lock mechanism (200) (e.g., one lock mechanism for each of the physical access points). It should be further appreciated, that the lock mechanism (200) may include any electromechanical lock (e.g., motorized screws), electromagnetic lock, and/or any suitable lock known in the art or discovered in the future. Further, the lock mechanism (200) includes functionality to perform at least a portion of the methods shown in FIGS. 3-5. One of ordinary skill will appreciate that the lock mechanism (200) may perform other functionalities without departing from the scope of the invention.

In one or more embodiments, the lock control module (202) includes the functionality to control the lock mechanism (200) (i.e., to send an appropriate electronic signal to lock or unlock the lock mechanism (200)). In one or more embodiments, the lock control module (202) may be configured to communicate with the hardware components (206). Further, the lock control module (202) includes functionality to perform at least a portion of the methods shown in FIGS. 3-5. One of ordinary skill will appreciate that the lock control module (202) may perform other functionalities without departing from the scope of the invention.

In one or more embodiments, the user interface (204) includes the functionality to receive user input (e.g., receive the access key from a user). It should be appreciated, that the user interface (204) (e.g., a graphical user interface, a command-line interface, etc.) may be configured to receive user input without departing from embodiments disclosed herein. Further, the user interface (204) includes functionality to perform at least a portion of the methods shown in FIGS. 3-5. One of ordinary skill will appreciate that the user interface (204) may perform other functionalities without departing from the scope of the invention

In one or more embodiments, the hardware components (206) may include any physical component operating within the SCS (e.g., 104 in FIG. 1) including but not limited to the BMC (208), the computing components (216), the storage components (218), and the communication components (220). In one or more embodiments, the hardware components (206) work together to facilitate the overall functionality of the SCS (e.g., 104 in FIG. 1). In one or more embodiments, the BMC (208) may include an audit module (not shown) configured to recording all system operations in an audit log (e.g., when and for how long the lock mechanism (200) was opened). Further, the hardware components (206) include functionality to perform at least a portion of the method shown in FIG. 3-5. One of ordinary skill will appreciate that the hardware components (206) may perform other functionalities without departing from the scope of the invention.

In one or more embodiments, the BMC (208) is a computing device that may include, a processor (not shown), the key storage module (212), the authentication module (210), the intrusion detection module (214), and may be configured to monitor and manage access to the hardware components (206). In one or more embodiments, the BMC (208) may include the functionality to generate the access key using the authentication tokens. A non-limiting example of the BMC (208) is an Integrated Dell® Remote Access Controller (iDRAC). Dell is a registered trademark of Dell, Inc. In one or more embodiments, a microcontroller (MCU), an embedded controller (EC), a BIOS, or any other system controllers may be used in place of the of the BMC (208) for remote or local operation. Further, the BMC (208) includes functionality to perform at least a portion of the methods shown in FIGS. 3-5. One of ordinary skill will appreciate that the BMC (208) may perform other functionalities without departing from the scope of the invention.

In one or more embodiments, the authentication module (210) includes functionality to determine if the access key is authentic (i.e., matches the access key that is entered via the user interface matches the access key that the authentication module expected to receive). It should be appreciated, that the authentication module (210) may determine if the access key is authentic by any means known in the art or discovered in the future. Further, the authentication module (210) includes functionality to perform at least a portion of the methods shown in FIGS. 3-5. One of ordinary skill will appreciate that the authentication module (210) may perform other functionalities without departing from the scope of the invention.

In one or more embodiments, the key storage module (212) includes functionality to store data (e.g., the access keys). The key storage module (212) may utilize volatile storage, non-volatile storage, or any combination thereof. Examples of storage include (but are not limited to): a hard disk drive (HDD), a solid-state drive (SSD), random access memory (RAM), flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, and virtualized memory. In one or more embodiments, the key storage module (212) may encrypt the data that it stores. Further, the key storage module (212) includes functionality to perform at least a portion of the method shown in FIG. 3-5. One of ordinary skill will appreciate that the key storage module (212) may perform other functionalities without departing from the scope of the invention.

In one or more embodiments, the intrusion detection module (214) includes the functionality to detect unauthorized access to the SCS (e.g., 104 in FIG. 1). It should be appreciated, that the intrusion detection module (214) may monitor access by any means known in the art or discovered in the future including but not limited to, physical means (e.g., a physical sensor on the chassis) and electronic means (e.g., monitoring the status of the hardware components (206)). In one or more embodiments, the intrusion detection module (214) may also monitor unsuccessful unlock attempts. In one or more embodiments, the intrusion detection module (214) may include the functionality to perform intrusion detection measures when unauthorized access is detected. It should be appreciated, that the intrusion detection module (214) may continuously monitor the SCS (e.g., 104 in FIG. 1). Further, the intrusion detection module (214) includes functionality to perform at least a portion of the methods shown in FIGS. 3-5. One of ordinary skill will appreciate that the intrusion detection module (214) may perform other functionalities without departing from the scope of the invention.

The computing components, the storage components, and the communication components are used to perform computing tasks that are typically performed by servers (e.g., data processing, data analytics, model training, website hosting, etc.). In addition, one or more of the aforementioned components may include functionality to perform some or all of the methods described herein.

In one or more embodiments, the computing components (216) include any components often found in a computer (e.g., processors, graphic processing units (GPUs), input/output controllers, network interfaces, etc.) that contribute to the functionality of the SCS (e.g., 104 in FIG. 1). Further, the computing components (216) include functionality to perform at least a portion of the methods shown in FIGS. 3-5. One of ordinary skill will appreciate that the computing components (216) may perform other functionalities without departing from the scope of the invention.

In one or more embodiments, the storage components (218) include functionality to store data. The storage components (218) may utilize volatile storage, non-volatile storage, or any combination thereof. Examples of storage include (but are not limited to): a hard disk drive (HDD), a solid-state drive (SSD), random access memory (RAM), flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, and virtualized memory. Further, the storage components (218) include functionality to perform at least a portion of the method shown in FIG. 3-5. One of ordinary skill will appreciate that the storage components (218) may perform other functionalities without departing from the scope of the invention.

In one or more embodiments, the communication components (220) include any computer hardware capable of facilitating data (e.g., authentication tokens and access keys) transfer between devices and/or networks (e.g., 102 in FIG. 1). It should be appreciated, that this may allow for remote control and monitoring of the SCS (e.g., 104 in FIG. 1). Further, the communication components (220) include functionality to perform at least a portion of the methods shown in FIG. 3-5. One of ordinary skill will appreciate that the communication components (220) may perform other functionalities without departing from the scope of the invention.

Turning to FIG. 3.1, FIG. 3.1 shows a method for sending an unlock request to a SCS (e.g., 104 in FIG. 1) in accordance with one or more embodiments of the invention. The method may be performed by, for example, a SCS (e.g., 104, FIG. 1). Other components in the system may perform this method without departing from the invention.

While the various steps in the flowchart shown in FIG. 3.1 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 300, an administrative system (e.g., 106 in FIG. 1) receives an unlock request from a user via a client system (e.g., 100 in FIG. 1). In one or more embodiments, the user request may include information related to which portion(s) of the SCS (e.g., 104 in FIG. 1) that the user would like to gain access to (i.e., unlock) and for how long (e.g., unlock front chassis for 30 minutes). Further, in one or more embodiments, the request may include the user's identity and/or why they would like to gain access to the SCS (e.g., 104 in FIG. 1), for example to perform maintenance on hardware components (e.g., 206 in FIG. 2). It should be appreciated, that the user may send the request by any means known in the art or discovered later.

In step 302, the administrative system (e.g., 106 in FIG. 1) generates an authentication token and access key based on the unlock request. In one or more embodiments, the authentication token and access key may be generated by any means known in the art or discovered in the future. It should be appreciated, that the authentication token may refer to an encrypted string of data containing information about the unlock request (i.e., which components to grant the user access to and for how long). It should be further appreciated, that the access key may refer to a unique string of characters and/or cryptographic variables that the user inputs into a user interface (e.g., 204 in FIG. 2) to gain access to the components in the SCS (e.g., 104 in FIG. 1). It should be further appreciated, that the authentication token may be associated with the access key. It should be appreciated, that there may be a discrepancy between what is requested by the user and what is granted in the access key based upon security policies. For example, the user may request access to components A, B, and C, but the access key may only unlock the lock mechanism(s) (e.g., 200 in FIG. 2) that grant access to components A and B because component C contains sensitive data that the user does not have authorization to access.

In step 304, the administrative system (e.g., 106 in FIG. 1) sends the authentication token and access key to the SCS (e.g., 104 in FIG. 1). In one or more embodiments, upon receiving the access key, the SCS (e.g., 104 in FIG. 1) stores the access key in a key storage module (e.g., 212 in FIG. 2).

In step 306, the administrative system (e.g., 106 in FIG. 1) sends the access key to the user via the client system (e.g., 100 in FIG. 1). It should be appreciated, that the access key may be sent the user by any means know in the art or discovered later.

In one or more embodiments, the method may end following step 306.

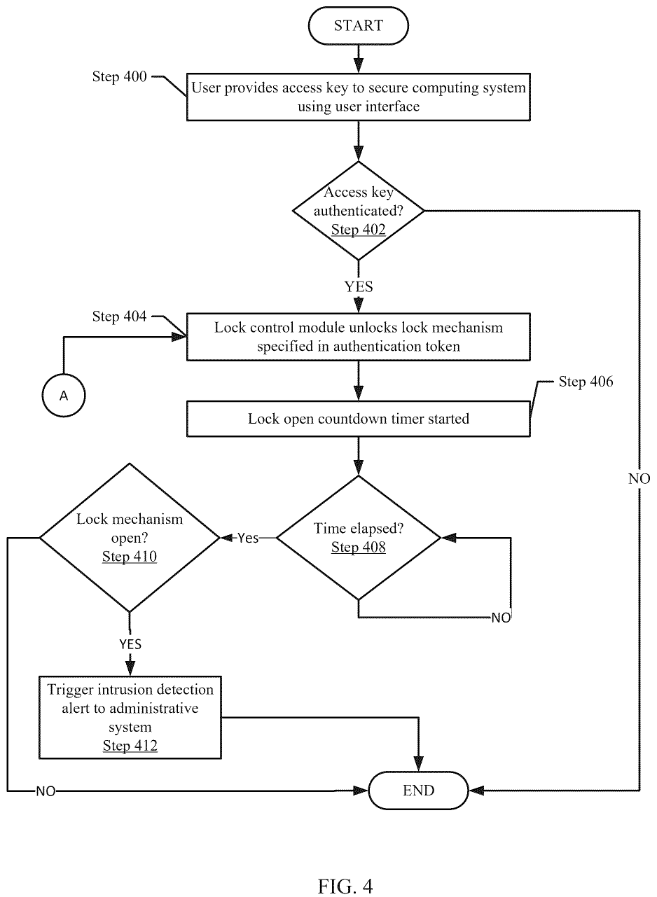

Following FIG. 3.1, a user may attempt to obtain access to the SCS using the access key via the method in FIG. 4.

Turning to FIG. 3.2, FIG. 3.2 shows a method for sending an unlock request to a SCS (e.g., 104 in FIG. 1) in accordance with one or more embodiments of the invention. The method may be performed by, for example, the SCS (e.g., 104, FIG. 1). Other components in the system may perform this method without departing from the invention.

While the various steps in the flowchart shown in FIG. 3.2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 308, an administrative system (e.g., 106 in FIG. 1) receives an unlock request from a user via a client system (e.g., 100 in FIG. 1). In one or more embodiments, the user request may include information related to which portion(s) of the SCS (e.g., 104 in FIG. 1) that the user would like to gain access to (i.e., unlock) and for how long (e.g., unlock front chassis for 30 minutes). Further, in one or more embodiments, the request may include the user's identity and/or why they would like to gain access to the SCS (e.g., 104 in FIG. 1), for example to perform maintenance on hardware components (e.g., 206 in FIG. 2). It should be appreciated, that the user may send the request by any means known in the art or discovered later.

In step 310, the administrative system (e.g., 106 in FIG. 1) generates an authentication token based on the unlock request. It should be appreciated, that the authentication token may refer to an encrypted string of data containing information about the unlock request (i.e., which components to grant the user access to and for how long). It should be appreciated, that the authentication token may be generated by any means known in the art or discovered in the future.

In step 312, the administrative system (e.g., 106 in FIG. 1) sends the authentication token to the SCS (e.g., 104 in FIG. 1). It should be appreciated, that the authentication token may be sent to the SCS (e.g., 104 in FIG. 1) by any means know in the art or discovered later.

In step 314, the BMC (e.g., 208 in FIG. 2) generates an access key based on the authentication token. In one or more embodiments, the access key may be generated by any means known in the art or discovered in the future. It should be further appreciated, that the access key may refer to a unique string of characters and/or cryptographic variables that the user inputs into a user interface (e.g., 204 in FIG. 2) to gain access to the components in the SCS (e.g., 104 in FIG. 1). In one or more embodiments, after generating the access key the SCS (e.g., 104 in FIG. 1) stores the access key in a key storage module (e.g., 212 in FIG. 2). It should be appreciated, that the authentication token may be associated with the access key. It should be further appreciated, that there may be a discrepancy between what is requested by the user and what is granted in the access key based upon security policies. For example, the user may request access to components A, B, and C, but the access key may only unlock the lock mechanism(s) (e.g., 200 in FIG. 2) that grant access to components A and B because component C contains sensitive data that the user does not have authorization to access.

In step 316, the SCS (e.g., 104 in FIG. 1) sends the access key to the user via the client system (e.g., 100 in FIG. 1). It should be appreciated, that the access key may be sent the user by any means know in the art or discovered in the future.

In one or more embodiments, the method may end following step 316.

Following FIG. 3.2, a user may attempt to obtain access to the SCS using the access key via the method in FIG. 4.

Turning to FIG. 4, FIG. 4 shows a method for unlocking a SCS (e.g., 104 in FIG. 1) in accordance with one or more embodiments of the invention. The method may be performed by, for example, the SCS (e.g., 104, FIG. 1). Other components in the system may perform this method without departing from the invention.

While the various steps in the flowchart shown in FIG. 4 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 400, a user provides an access key to the SCS (e.g., 104, FIG. 1) using a user interface (e.g., 204 in FIG. 2).

In step 402, an authentication module (e.g., 210 in FIG. 2) determines whether the access key is authentic. It should be appreciated, that the authentication module (e.g., 210 in FIG. 2) may use any means known in the art or discovered in the future to determine whether the access key is authentic. Accordingly, if the result of this determination is YES, the method proceeds to step 404. If the result of the determination is NO, the method may end.

In step 404, a lock control module (e.g., 202 in FIG. 2) unlocks a lock mechanism (e.g., 200 in FIG. 2). It should be appreciated, that the lock mechanism(s) (e.g., 200 in FIG. 2) that is unlocked may correspond to the lock mechanism(s) specified by an authentication token associated with the access key. In one or more embodiments, in response to unlocking the lock mechanism (e.g., 200 in FIG. 2) the intrusion detection module (e.g., 214 in FIG. 2) may generate and store a corresponding audit log entry. In one or more embodiments, the lock control module (e.g., 202 in FIG. 2) may be configured to open up a first lock mechanism (e.g., 200 in FIG. 2) and a second lock mechanism (e.g., 200 in FIG. 2), wherein after unlocking the first lock mechanism (e.g., 200 in FIG. 2), the second lock mechanism (e.g., 200 in FIG. 2) will only unlock after the first lock mechanism (e.g., 200 in FIG. 2) has been re-locked.

In step 406, an intrusion detection module (e.g., 214 in FIG. 2) begins a countdown in response to the lock mechanism (e.g., 200 in FIG. 2) being unlocked. In one or more embodiments, the length of the countdown may be set by the authentication token and/or the access key. It should be appreciated, that the length of the countdown may be also set based on many variables including but not limited to, the particular lock mechanism (e.g., 200 in FIG. 2) that the user unlocks, the user's identity, time of day that the lock mechanism (e.g., 200 in FIG. 2) is unlocked, the quantity of lock mechanisms (e.g., 200 in FIG. 2) unlocked, etc. In one or more embodiments, there may be more than one countdown based on the number of lock mechanisms that are unlocked. In one or more embodiments, the countdown may be canceled by relocking the lock mechanism (e.g., 200 in FIG. 2). In one or more embodiments, the lock mechanism may be relocked by any means known in the art or discovered in the future including but not limited to a physical key, a button on the user interface (e.g., 204 in FIG. 2), etc.

In step 408, the intrusion detection module (e.g., 214 in FIG. 2) determines whether the countdown has ended (i.e., the timer has reached zero). Accordingly, if the result of this determination is YES, the method proceeds to step 410. If the result of the determination is NO, then step 408 is repeated.

In step 410, the intrusion detection module (e.g., 214 in FIG. 2) determines whether the lock mechanism (e.g., 200 in FIG. 2) is open. In one or more embodiments, the intrusion detection module (e.g., 214 in FIG. 2) may make the determination by checking the status of the lock control module (e.g., 202 in FIG. 2). It should be appreciated, that the intrusion detection module (e.g., 214 in FIG. 2) may make the determination by any means known in the art or discovered in the future. Accordingly, if the result of this determination is YES, the method proceeds to step 412. If the result of the determination is NO, then the method may end.

In step 412, the intrusion detection module (e.g., 214 in FIG. 2) triggers intrusion detection measures in response to the countdown expiring. In one or more embodiments, the intrusion detection measures may include at least one of, an on-site alarm, re-locking the lock mechanism (e.g., 200 in FIG. 2), encrypting data from at least one of the hardware components (e.g., 206 in FIG. 2), deleting data from at least one of the hardware components (e.g., 206 in FIG. 2), backing up data from at least one of the hardware components (e.g., 206 in FIG. 2), shutting down the SCS (e.g., 104 in FIG. 1), notifying an administrative system (e.g., 106 in FIG. 1), etc.

In one or more embodiments, the lock mechanism (e.g., 200 in FIG. 2) may be unlocked while the SCS (e.g., 104 in FIG. 1) is in a powered-off state. In this scenario, upon a subsequent power-up, the unlock may be reported to the BMC (e.g., 208 in FIG. 2) and the administrative system (e.g., 106 in FIG. 1), and the BMC (e.g., 208 in FIG. 2) may block a system boot pending verification by the administrative system (e.g., 106 in FIG. 1).

In one or more embodiments, the method may end following step 412.

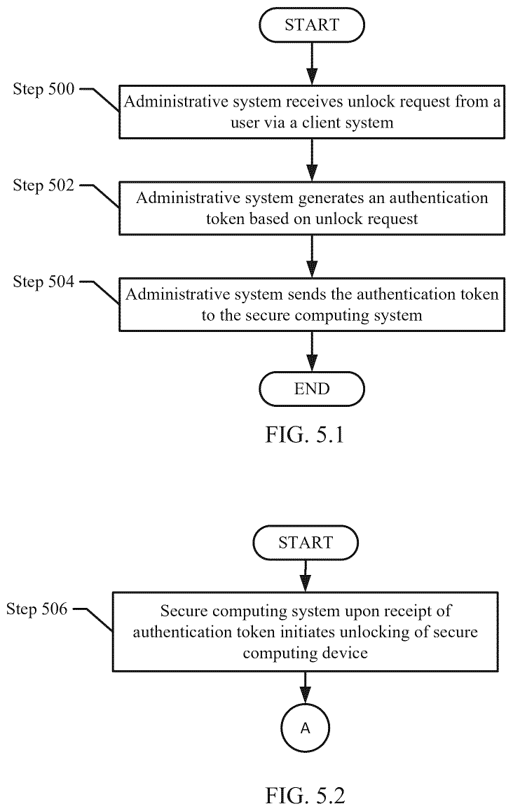

Turning to FIG. 5.1, FIG. 5.1 shows a method for sending an unlock request to a SCS (e.g., 104 in FIG. 1) in accordance with one or more embodiments of the invention. The method may be performed by, for example, a SCS (e.g., 104, FIG. 1). Other components in the system may perform this method without departing from the invention.

While the various steps in the flowchart shown in FIG. 5.1 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 500, the administrative system (e.g., 106 in FIG. 1) receives an unlock request from a user via a client system (e.g., 100 in FIG. 1). In one or more embodiments, the user request may include information related to which portion(s) of the SCS (e.g., 104 in FIG. 1) that the user would like to gain access to (i.e., unlock) and for how long (e.g., unlock front chassis for 30 minutes). Further, in one or more embodiments, the request may include the user's identity and/or why they would like to gain access to the SCS (e.g., 104 in FIG. 1), for example to perform maintenance on hardware components (e.g., 206 in FIG. 2). It should be appreciated, that the user may send the request by any means known in the art or discovered later.

In step 502, the administrative system (e.g., 106 in FIG. 1) generates an authentication token based on the unlock request. It should be appreciated, that the authentication token may refer to an encrypted string of data containing information about the unlock request (i.e., which components to grant the user access to and for how long). It should be appreciated, that the authentication token may be generated by any means known in the art or discovered in the future.

In step 504, the administrative system (e.g., 106 in FIG. 1) sends the authentication token to the SCS (e.g., 104 in FIG. 1). It should be appreciated, that the authentication token may be sent the SCS (e.g., 104 in FIG. 2) by any means know in the art or discovered latter.

In one or more embodiments, the method may end following step 504.

Turning to FIG. 5.2, FIG. 5.2 shows a method for unlocking a SCS (e.g., 104 in FIG. 1) in accordance with one or more embodiments of the invention. The method may be performed by, for example, a SCS (e.g., 104, FIG. 1). Other components in the system may perform this method without departing from the invention.

While the various steps in the flowchart shown in FIG. 5.2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 506, a SCS (e.g., 104, FIG. 1) upon receipt of an authentication token initiates unlocking of the SCS (e.g., 104, FIG. 1). In one or more embodiments, the SCS (e.g., 104, FIG. 1) may receive the authentication token from the administrative system (e.g., 106 in FIG. 1).

In one or more embodiments, the method may proceed to step 404 in FIG. 4.

Embodiments of the disclosure may be implemented using computing devices. Turning to FIG. 6, FIG. 6 shows a diagram of a computing device (600) in accordance with one or more embodiments. The computing device (600) may include one or more computer processor(s) (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (608) (e.g., Bluetooth interface, infrared interface, network interface, optical interface, etc.), input devices (610), output devices (612), and numerous other elements (not shown) and functionalities. Each of these components is described below.

In one embodiment, the computer processor(s) (602) may be an integrated circuit for processing instructions. For example, the computer processor(s) (602) may be one or more cores or micro-cores of a processor. The computing device (600) may also include one or more input devices (610), such as a touchscreen, access keyboard, mouse, microphone, touchpad, electronic pen, or any other type of input device. The communication interface (608) may include an integrated circuit for connecting the computing device (600) to a network (not shown) (e.g., a local area network (LAN), a wide area network (WAN) such as the Internet, mobile network, or any other type of network) and/or to another device, such as another computing device.

In one embodiment, the computing device (600) may include one or more output devices (612), such as a screen (e.g., a liquid crystal display (LCD), a plasma display, touchscreen, cathode ray tube (CRT) monitor, projector, or other display device), a printer, external storage, or any other output device. One or more of the output devices (612) may be the same or different from the input devices (610). The input and output device(s) (610, 612) may be locally or remotely connected to the computer processor(s) (602), non-persistent storage (604), and persistent storage (606). Many diverse types of computing devices exist, and the aforementioned input and output device(s) (610, 612) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the above detailed description of the embodiments of the invention, numerous specific details are set forth in order to provide a more thorough understanding of one or more embodiments of the invention. However, it will be apparent to one of ordinary skill in the art that the one or more embodiments of the invention may be practiced without these specific details. In other instances, well-known features have not been described in detail to avoid unnecessarily complicating the description.

In the prior description of the figures, any component described with regard to a figure, in various embodiments of the invention, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, throughout this application, elements of figures may be labeled as A to N. As used herein, the aforementioned labeling means that the element may include any number of items and does not require that the element include the same number of elements as any other item labeled as A to N unless otherwise specified. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

Software instructions in the form of computer readable program code to perform embodiments described herein may be stored, in whole or in part, temporarily or permanently, on a non-transitory computer readable medium such as a CD, DVD, storage device, a diskette, a tape, flash memory, physical memory, or any other physical computer readable storage medium. Specifically, the software instructions may correspond to computer readable program code that, when executed by a processor(s), is configured to perform one or more embodiments described herein.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for unlocking a secure computing system, the method comprising:
entering a first access key by a user via a user interface of the secure computing system, wherein the first access key is generated by an administrative system that is external to the secure computing system;
authenticating, by the secure computing system, the first access key; and
in response to the authentication, initiating an unlocking of a first lock mechanism on the secure computing system, wherein once unlocked, the user may access at least one hardware component located within the secure computing system.

2. The method of claim 1,
wherein the first access key is associated with an first authentication token,
wherein authentication token specifies the first lock mechanism and a duration of time that the first lock mechanism can be unlocked.

3. The method of claim 2, wherein the first authentication token further specifies unlocking a second lock mechanism in the secure computing system after the first lock mechanism is re-locked.

4. The method of claim 2, wherein the first lock mechanism, when locked, secures at least one cover of the secure computing system.

5. The method of claim 2, wherein the first lock mechanism, when locked, secures the at least one hardware component within a chassis.

6. The method of claim 2, further comprising:
after the unlocking:
making a first determination that the duration of time has elapsed;
making, in response to the first determination, a second determination that the first lock mechanism is unlocked; and
in response to the second determination, triggering intrusion detection measures.

7. The method of claim 1, further comprising:
in response to the authentication, initiating an unlocking of a second lock mechanism on the secure computing system, wherein once unlocked, the user may access at least one other hardware component of the secure computing system.

8. The method of claim 1, further comprising:
entering a second access key by the user via the user interface of the secure computing system, wherein the second access key is generated by the administrative system;
authenticating, by the secure computing system, the second access key; and
in response to the authentication initiating an unlocking of a second lock mechanism on the secure computing system, wherein once unlocked, the user may access at least one other hardware component of the secure computing system.

9. The method of claim 8,
wherein the first access key is associated with a first authentication token,
wherein the second access key is associated with a second authentication token,
wherein first authentication token specifies the first lock mechanism and a duration of time that the first lock mechanism can be unlocked, and
wherein second authentication token specifies the second lock mechanism and a duration of time that the second lock mechanism can be unlocked.

10. The method of claim 1,
wherein the secure computing system comprises a chassis, and
wherein the user interface is mounted on the chassis.

11. A method for unlocking a secure computing system, the method comprising:
entering a first access key by a user via a user interface of the secure computing system, wherein the first access key is generated by the secure computing system in response to receiving a first authentication token from an administrative system, wherein the administrative system is external to the secure computing system;
authenticating, by the secure computing system, the first access key; and
in response to the authentication, initiating an unlocking of a first lock mechanism on the secure computing system, wherein once unlocked, the user may access at least one hardware component of the secure computing system.

12. The method of claim 11,
wherein first authentication token specifies the first lock mechanism and a duration of time that the first lock mechanism can be unlocked.

13. The method of claim 12, wherein the first authentication token further specifies unlocking a second lock mechanism in the secure computing system after the first lock mechanism is re-locked.

14. The method of claim 12, wherein the first lock mechanism, when locked, secures at least one cover of the secure computing system.

15. The method of claim 12, wherein the first lock mechanism, when locked, secures the at least one hardware component within a chassis.

16. The method of claim 12, further comprising:
after the unlocking:
making a first determination that the duration of time has elapsed;
making, in response to the first determination, a second determination that the first lock mechanism is unlocked; and
in response to the second determination, triggering intrusion detection measures.

17. The method of claim 11, further comprising:
in response to the authentication, initiating an unlocking of a second lock mechanism on the secure computing system, wherein once unlocked, the user may access at least one other hardware component of the secure computing system.

18. The method of claim 11, further comprising:
entering a second access key by the user via the user interface of the secure computing system, wherein the second access key is generated by the administrative system;
authenticating, by the secure computing system, the second access key; and
in response to the authentication initiating an unlocking of a second lock mechanism on the secure computing system, wherein once unlocked, the user may access at least one other hardware component of the secure computing system.

19. The method of claim 18,
wherein the first access key is associated with the first authentication token,
wherein the second access key is associated with a second authentication token,
wherein first authentication token specifies the first lock mechanism and a duration of time that the first lock mechanism can be unlocked, and
wherein second authentication token specifies the second lock mechanism and a duration of time that the second lock mechanism can be unlocked.

20. A secure computing system, comprising:
a chassis comprising a user interface;
a lock mechanism;
a lock control module operatively connected to the lock mechanism;
hardware components;
a base board management controller comprising executable instructions, which when executed perform a method, the method comprising:
receiving an access key via the user interface, wherein the access key is generated by:
an administrative system that is external to the secure computing system, or the secure computing system;
authenticating the access key; and
in response to the authentication, instructing the lock control module to initiate an unlocking of the lock mechanism, wherein once unlocked, a user may access at least one of the hardware components.
